(19) United States
(12) Patent Application Publication
(10) Pub. No.: US 2005/0173661 A1
(43) Pub. Date: Aug. 11, 2005

(54) Spaceship valve with actuator made of shape-memory alloy

(76) Inventors: Anthony Mignon, Vise (BE); Rudy Stalmans, Aarschot (BE)

Correspondence Address: KNOBBE MARTENS OLSON & BEAR LLP, 2040 MAIN STREET, FOURTEENTH FLOOR, IRVINE, CA, 92614, US

(21) Appl. No.: 11/015,759

(22) Filed: Dec. 17, 2004

(30) Foreign Application Priority Data
Dec. 23, 2003 (EP) 03447305.8

(51) Int. Cl. F16K 31/00; F16K 31/18; H05B 1/00; H05B 3/00; H05B 11/00

(52) U.S. Cl. 251/11

(57) ABSTRACT

The present invention relates to a valve with an actuator (3) essentially made of shape-memory alloy (SMA) and provided with means for controlling the activation temperature of the actuator, wherein the means comprises a reverse biasing mechanism (2).

### CROSS REFERENCE TO RELATED APPLICATIONS

This Application claims priority under 35 U.S.C. § 119 to European Patent Application Serial No. 03447305.8, which was filed on Dec. 23, 2003, the entire contents of which is incorporated herein by reference.

### FIELD OF THE INVENTION

The present invention relates to a valve with an actuator made of a shape-memory alloy (SMA) which has a system allowing to control the activation temperature of the valve.

The valve described in the present document is intended to be used in the propulsion systems of spaceships, more precisely in the pressurisation systems, where it allows to open or to close a pipe by means of a specific electric control.

### STATE OF THE ART

The remarkable properties of shape-memory alloys (SMA's) are already known, they are due to a transformation of thermoelastic phases during which an initial austenitic phase is reversibly followed by a martensitic phase. This transition occurs under the effect of a variation in temperature and/or with the application of a mechanical stress. Among the numerous properties recorded, the single-direction memory effect should be noted, where the martensitic material recovers its initial shape when it is reheated above its transformation range. Depending on the thermomechanical processes undergone, the memory effect may also be bidirectional.

The SMA's currently known and used in the manufacture of valves or other mechanisms have a transition temperature (from the martensitic phase to the austenitic phase) of at best 85° C., (Nitinol®, titanium-nickel alloy). This means that, as soon as this temperature of 85° C. is exceeded, the valve or the mechanism is spontaneously activated without any other external stimulus.

The characteristic thermal environments of valves for the pressurisation of propulsion systems for spaceships can range between −90° C. and +100° C. The use of a standard shape-memory alloy is therefore excluded because of the risk of spontaneous activation of the valve, the consequences of which would be catastrophic for the mission (for example total loss of the ship, abandonment of the mission).

Consequently, it is necessary to find a solution allowing to raise the value of the SMA's transition temperature above +100° C., and even to obtain some safety margin relative to this temperature value.

The present invention aims to provide a solution that does not include the disadvantages associated with the state of the art regarding the use of actuators made of shape-memory alloys in valves.

In particular, one aim of the invention is to allow the use of such an actuator in a thermal environment characteristic of propulsion systems in spaceships, for instance extending beyond +100° C., without any risk of spontaneous activation of the valve.

Thus, a complementary aim of the invention is to provide a solution allowing to raise the value of the transition temperature of the shape-memory alloy above +100° C.

### SUMMARY

The present invention relates to a valve with an actuator essentially made of shape-memory alloy (SMA) and provided with means for controlling the activation temperature of said actuator, characterised in that said means comprises a reverse biasing mechanism.

According to a first preferred embodiment of the invention, the reverse biasing mechanism is of the breakable “pin” type.

According to a second preferred embodiment of the invention, the reverse biasing mechanism is of the spring latch type.

Preferably, the SMA is a titanium-nickel alloy.

The valve according to the invention is of the normally open or normally closed type.

As an advantage, the activation temperature of the valve is higher than 100° C., preferably higher than 110° C.

As a particular advantage, the biasing mechanism is designed in such a way that the force required to overcome the biasing element (F_{bias}) is related to the force required to open or close the flow section of the fluid (F_{open/close}).

Preferably, the biasing mechanism is designed so that the difference between the two forces is maximised.

Still according to the invention, the valve has electrical heating means for inducing the activation of the SMA actuator.

The invention also relates to the use of the valve described and claimed in the propulsion systems of spaceships, preferably in the pressurisation circuits of said systems.

### SHORT DESCRIPTION OF THE DRAWINGS

FIG. 1 diagrammatically shows the principle of “reverse biasing”.

FIG. 2 shows the features of a biasing mechanism of the breakable “pin” type or of the spring latch type.

FIGS. 3.a and 3.b diagrammatically show the opening mechanism according to the invention in the case of a valve that is normally closed with reverse biasing of the breakable “pin” type.

### DETAILED DESCRIPTION OF THE INVENTION

The invention consists in relying on the “reverse biasing” principle in order to increase the activation temperature of the valve above +100° C. The “reverse biasing”, the principle of which is illustrated in FIG. 1, is characterised by the use of a high initial force on the element made of shape-memory alloy (SMA), in order to maximise the increase in the transition temperature of the latter. This force then decreases during the SMA's change of shape.

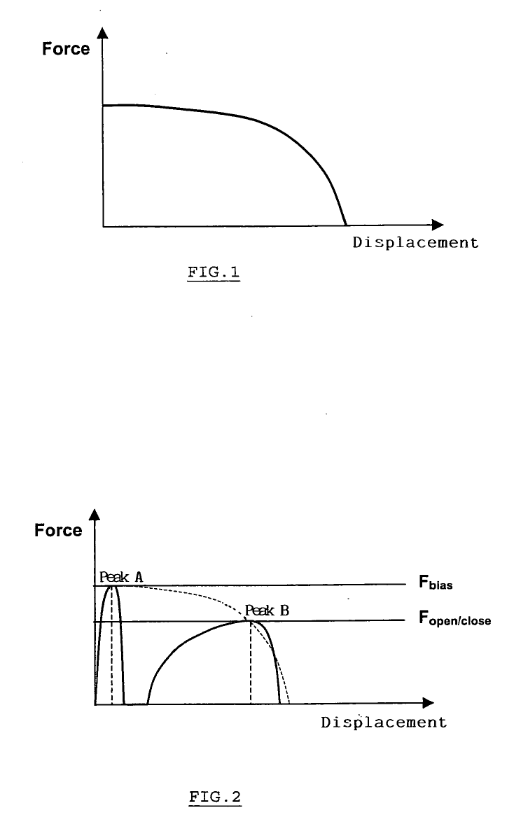

In order to minimise the energy consumption of the actuator, it is essential to minimise the area located under the curve of FIG. 1 presented above. The solution proposed is to use a biasing mechanism of the breakable “pin” type or a spring latch system, both of them characterised as described in FIG. 2.

Peak A (F_{bias} force) represents the energy that must be supplied by the actuator in order to overcome the biasing element, whereas peak B (F_{open/close} force) represents the energy required to open or to close the flow section of the fluid, depending on whether the valve is a valve that is normally closed (NC) or normally open (NO), respectively.

When controlling the relative levels of peaks A and B, the range of activation temperature can be precisely regulated. Moreover, the control of peaks A and B allows to regulate the opening or closing speeds of the valve. Indeed, the greater the difference between F_{bias} and F_{open/close} the more abrupt the activation of the valve will be.

### DESCRIPTION OF A PREFERRED EMBODIMENT OF THE INVENTION

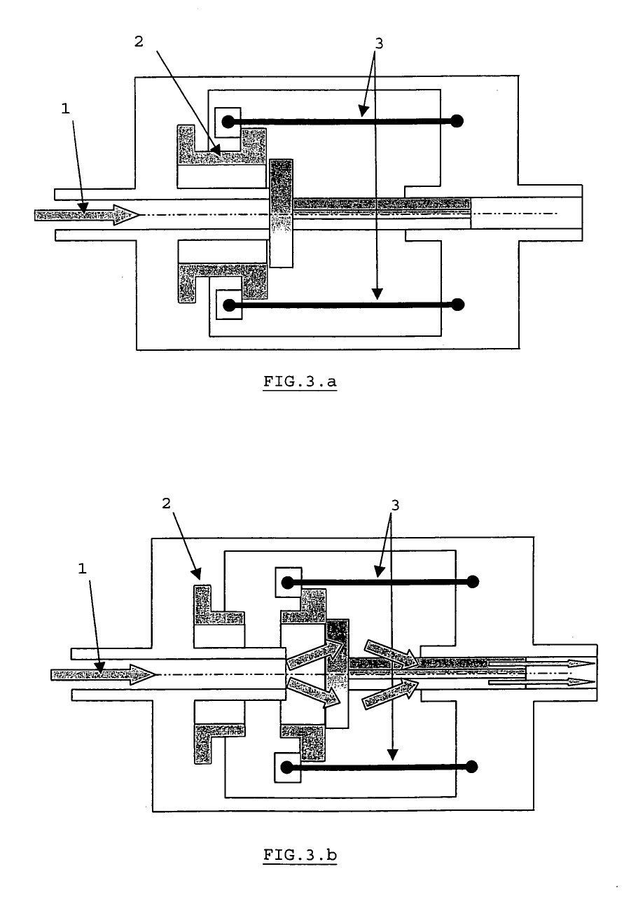

According to a preferred embodiment of the invention, the implementation of “reverse biasing” in a valve for space applications may be diagrammatically illustrated as in FIGS. 3.a and 3.b.

FIGS. 3.a and 3.b correspond to a valve that is normally closed with a breakable “pin” (Reference 2 in the figures), but the principle is similar for a valve that is normally open and/or for a valve with a “spring latch” type bias.

The activation of the SMA element is achieved by heating, for instance by direct Joule effect, i.e. by letting an electric current pass through the SMA, which is in the form of wires 3. This current must be sufficient to bring the SMA to a temperature higher than or equal to the activation temperature chosen by sizing the SMA and its bias (>100° C.). In the example shown here, the SMA is chosen so that it will contract during the temperature transition.

The main advantage of the present invention lies in the possibility of using an SMA actuator above its conventional temperature of use without the risk of spontaneous activation.

1. A valve comprising: an actuator essentially made of a shape-memory alloy and provided with means for controlling an activation temperature of said actuator, wherein said means comprises a reverse biasing mechanism.

2. The valve as in claim 1, wherein the reverse biasing mechanism is of a breakable “pin” type.

3. The valve as in claim 1, wherein the reverse biasing mechanism is of a spring latch type.

4. The valve as in claim 1, wherein the shape-memory alloy is a titanium-nickel alloy.

5. The valve as in claim 1, wherein it is of a normally open or normally closed type.

6. The valve as in claim 1, wherein an activation temperature of the valve is higher than 100° C.

7. The vale as in claim 6, wherein the activation temperature of the valve is higher than 110 ° C.

8. The valve as in claim 1, wherein the biasing mechanism is configured such that a force required to overcome the biasing element is related to a force required to open or close a flow section of a fluid.

9. The valve as in claim 8, wherein the biasing mechanism is configured such that a difference between the two forces is maximised.

10. The valve as in claim 1, further comprising an electrical heater for inducing activation of the shape-memory alloy actuator.

11. A method of using a valve comprising: providing a valve made essentially of a shape-memory alloy and having means for controlling an activation temperature of said actuator, wherein said means comprises a reverse biasing mechanism, in a propulsion system of a spaceship.

12. The method of claim 11, further comprising providing the valve in a pressurisation circuit of said propulsion system.
